(19) United States
(12) Patent Application Publication
(10) Pub. No.: US 2023/0214694 A1
(43) Pub. Date: Jul. 6, 2023

(54) DATA PROCESSING METHOD AND ELECTRONIC DEVICE

(71) Applicant: NEC CORPORATION, Tokyo (JP)

(72) Inventors: Erli WANG, Beijing (CN); Lu FENG, Beijing (CN)

(73) Assignee: NEC CORPORATION, Tokyo (JP)

(21) Appl. No.: 18/148,779

(22) Filed: Dec. 30, 2022

(30) Foreign Application Priority Data
Dec. 30, 2021 (CN) 202111652939.2

(51) Int. Cl. G06N 5/045; G06N 5/022

(52) U.S. Cl. CPC G06N 5/045; G06N 5/022

(57) ABSTRACT

Embodiments of the present disclosure relate to a data processing method and an electronic device, and relate to a field of computers. The method comprises: acquiring data to be processed, the data to be processed indicating at least one of: first state information, a first action, and second state information after executing the first action when the first state information is satisfied; determining result data based on the data to be processed using a trained data generation model, the result data indicating third state information after executing a second action when the first state information is satisfied, and the data generation model being obtained based on a training set and a causal model corresponding to at least one data item in the training set; and outputting the result data. In this way, the embodiments of the present disclosure can output result data corresponding to the data to be processed based on the trained data generation model, so as to realize data augmentation and to facilitate further processing based on the dataset.

### CROSS-REFERENCES TO RELATED APPLICATIONS

This application claims priority to CN Application No. 202111652939.2, entitled automatically and efficiently DATA PROCESSING METHOD AND ELECTRONIC DEVICE, and filed on Dec. 30, 2021, the entire contents of that application being incorporated herein by reference in its entirety.

### FIELD

Embodiments of the present disclosure generally relate to a field of computers, and more specifically, to a data processing method, a model training method, an electronic device, a computer-readable storage medium, and a computer program product.

### BACKGROUND

With the development of technologies, Artificial Intelligence (AI) has been applied to a variety of industries. The application of AI in various fields relies on algorithms such as machine learning, neural network, and the like, and those AI algorithms are typically obtained through massive data-based training.

A large majority of the algorithms are designed on an assumption of data balance, environment balance, and the like. In general, data are collected from actual scenarios in various fields, but the data collected in practice are not comprehensive enough. For example, in the medical field, obviously more data for the cured are on record than those for the uncured. For another example, in the field of customer satisfaction, there are significantly more data on satisfaction than dissatisfaction. Correspondingly, most of the current algorithms are derived on the basis of incomplete data, leading to problems such as degraded prediction performance of the algorithm and the like.

Under the condition of limited actual data, how to acquire more valid, reasonable data is one of the problems to be solved at present.

### SUMMARY

Exemplary embodiments of the present disclosure provide a solution for data processing, to obtain counterfactual data for subsequent processing.

According to a first aspect of the present disclosure, there is provided a data processing method, comprising: acquiring data to be processed, the data to be processed indicating at least one of: first state information, a first action, and second state information after executing the first action when the first state information is satisfied; determining result data based on the data to be processed using a trained data generation model, the result data indicating third state information after executing a second action when the first state information is satisfied, and the data generation model being obtained based on a training set and a causal model corresponding to at least one data item in the training set; and outputting the result data.

According to a second aspect of the present disclosure, there is provided a data processing method, comprising: acquiring data to be processed, the data to be processed indicating at least one of: first state information, a first action, first attribute information, and second state information after an object with the first attribute information executes the first action when the first state information is satisfied; inputting at least one of the first state information, the first action, and the second state information into a first submodel of a trained data generation model, to obtain an influence parameter corresponding to the data to be processed, the influence parameter comprising second attribute information and a noise parameter; inputting the first state information, the first action and the influence parameter into a second submodel of the trained data generation model, to obtain result data, the result data indicating third state information after an object with the second attribute information executes the first action when the first state information is satisfied; and outputting the result data.

According to a third aspect of the present disclosure, there is provided a model training method, comprising: constructing a training set, the training set comprising a plurality of data items, each of the plurality of data items comprising at least one of: first state information, an action, and second state information after executing the action when the first state information is satisfied; acquiring a causal model corresponding to at least one data item in the training set; and generating a trained data generation model at least based on the training set and the causal model.

According to a fourth aspect of the present disclosure, there is provided an electronic device, comprising: at least one processing unit; and at least one memory being coupled to the at least one processing unit and configured to store instructions for being executed by the at least one processing unit, the instructions, when executed by the at least one processing unit, causing the device to perform actions, the actions comprising: acquiring data to be processed, the data to be processed indicating at least one of: first state information, a first action, and second state information after executing the first action when the first state information is satisfied; determining result data based on the data to be processed using a trained data generation model, the result data indicating third state information after executing a second action when the first state information is satisfied, and the data generation model being obtained based on a training set and a causal model corresponding to at least one data item in the training set; and outputting the result data.

According to a fifth aspect of the present disclosure, there is provided an electronic device, comprising: at least one processing unit; and at least one memory being coupled to the at least one processing unit and configured to store instructions for being executed by the at least one processing unit, the instructions, when executed by the at least one processing unit, causing the device to perform actions, the actions comprising: acquiring data to be processed, the data to be processed indicating at least one of: first state information, a first action, first attribute information, and second state information after an object with the first attribute information executes the first action when the first state information is satisfied; inputting at least one of the first state information, the first action, and the second state information into a first submodel of a trained data generation model, to obtain an influence parameter corresponding to the data to be processed, the influence parameter comprising second attribute information and a noise parameter; inputting the first state information, the first action and the influence parameter into a second submodel of the trained data generation model, to obtain result data, the result data indicating third state information after an object with the second attribute information executes the first action when the first state information is satisfied; and outputting the result data.

According to a sixth aspect of the present disclosure, there is provided an electronic device, comprising: at least one processing unit; and at least one memory being coupled to the at least one processing unit and configured to store instructions for being executed by the at least one processing unit, the instructions, when executed by the at least one processing unit, causing the device to perform actions, the actions comprising: constructing a training set, the training set comprising a plurality of data items, each of the plurality of data items comprising at least one of: first state information, an action, and second state information after executing the action when the first state information is satisfied; acquiring a causal model corresponding to at least one data item in the training set; and generating a trained data generation model at least based on the training set and the causal model.

According to a seventh aspect of the present disclosure, there is provided an electronic device, comprising: a memory and a processor; wherein the memory is configured to store one or more computer instructions, wherein the one or more computer instructions are executed by the processor to perform the method described according to the first, second or third aspect of the present disclosure.

According to an eighth aspect of the present disclosure, there is provided a computer readable storage medium having machine-executable instructions stored thereon, the machine-executable instructions, when executed by a device, cause the device to perform the method described according to the first, second or third aspect of the present disclosure.

According to a ninth aspect of the present disclosure, there is provided a computer program product comprising computer-executable instructions, the computer-executable instructions, when executed by a processor, implement the method described according to the first, second or third aspect of the present disclosure.

According to a tenth aspect of the present disclosure, there is provided an electronic device, comprising a processing circuitry apparatus configured to perform the method described according to the first, second or third aspect of the present disclosure.

The Summary is to introduce a series of concepts in a simplified form which will be further described in the Detailed Description. The Summary is not intended to identify key features or essential features of the present disclosure, nor is it intended to be used to limit the scope of the present disclosure. Other features of the present disclosure will be made apparent by the following depictions.

### BRIEF DESCRIPTION OF THE DRAWINGS

The above and other features, advantages and aspects of the present disclosure will become more apparent through the detailed description below with reference to the accompanying drawings. Throughout the drawings, same or similar reference numerals represent same or similar elements, wherein:

FIG. 1 illustrates a block diagram of an example environment according to embodiments of the present disclosure;

FIG. 2 illustrates a schematic diagram of representation meanings of a data item according to embodiments of the present disclosure;

FIG. 3 illustrates a flowchart of an example training process according to embodiments of the present disclosure;

FIG. 4 illustrates a schematic diagram of a DAG according to embodiments of the present disclosure;

FIG. 5 illustrates a flowchart of an example usage process according to embodiments of the present disclosure;

FIG. 6 illustrates a flowchart of an example usage process according to embodiments of the present disclosure;

FIG. 7 illustrates a flowchart of an example usage process according to embodiments of the present disclosure;

FIG. 8 illustrates a schematic process according to embodiments of the present disclosure;

FIG. 9 illustrates a flowchart of an example process of determining a target decision according to embodiments of the present disclosure; and

FIG. 10 illustrates a block diagram of an example device according to embodiments of the present disclosure.

### DETAILED DESCRIPTION OF EMBODIMENTS

Hereinafter, embodiments of the present disclosure will be described in more detail with reference to the accompanying drawings. Although the drawings illustrate some embodiments of the present disclosure, it is to be understood that the present disclosure can be implemented in various ways, and the illustrated embodiments should not be construed as being limited to the embodiments set forth herein. On the contrary, these embodiments are provided to enable a more thorough and complete understanding of the present disclosure. It is to be appreciated that the drawings and embodiments of the present disclosure are only used for exemplary purposes, and are not intended to limit the protection scope of the present disclosure.

As used herein, the term “includes” and its equivalents are to be read as open terms that mean “includes, but is not limited to.” The term “based on” is to be read as “based at least in part on.” The terms “one embodiment” or “the embodiment” is to be read as “at least one example embodiment.” The term “first,” “second,” and the like may refer to different or the same objects. Other definitions, either explicit or implicit, may be included below.

Various methods and processes described in the embodiments of the present disclosure may also be applied to various kinds of electronic devices, e.g., terminal devices, network devices, etc. The embodiments of the present disclosure may also be executed in a test device, such as a signal generator, a signal analyzer, a spectrum analyzer, a network analyzer, a test terminal device, a test network device, and a channel simulator, etc.

The term “circuitry” used herein may refer to hardware circuits and/or combinations of hardware circuits and software. For example, the circuitry may be a combination of analog and/or digital hardware circuits with software/firmware. As an alternative example, the circuitry may be any portions of hardware processors with software including digital signal processor(s), software, and memory(ies) that work together to cause an apparatus, such as a computing device and the like, to perform various functions. In a still further example, the circuitry may be hardware circuits or processors, such as a microprocessor or a portion of a microprocessor, that requires software/firmware for operation, but the software may not be present when it is not needed for operation. As used herein, the term “circuitry” also covers implementation of merely a hardware circuit or processor(s), or a fraction of a hardware circuit or processor(s) in conjunction with the software and/or firmware affixed thereto.

As for the problems in lots of fields, intelligent bodies all need to make a series of decisions to fulfil a particular task, for example, decisions to be taken into the consideration by AlphaGo when playing Go. A reinforcement learning (RL) algorithm aims to learn the optimal strategy in the premise of attaining the maximized cumulative reward, so it has been widely applied to fields such as automatic driving, business management, recommendation system and the like. Nevertheless, the conventional reinforcement learning algorithms are still disadvantageous in data validity and others.

Improving data validity generates a need for lots of prior knowledge or more information derived from the existing data. A model-based reinforcement learning algorithm can learn a dynamic model of an environment, but its model assumption introduces model bias while improving the data validity, resulting in failure to meet the required performance. Through the data synthesis technology, synthesized data are obtained by up-sampling the existing data, but such mechanism is uncontrollable, thus generating limitations in application field.

In view of the above, embodiments of the present disclosure provide a data reinforcement solution to solve one or more of the above and/or other potential problems. In the solution, a trained data generation model obtained based on a causal model may be utilized to determine result data corresponding to data to be processed, thereby attaining data augmentation.

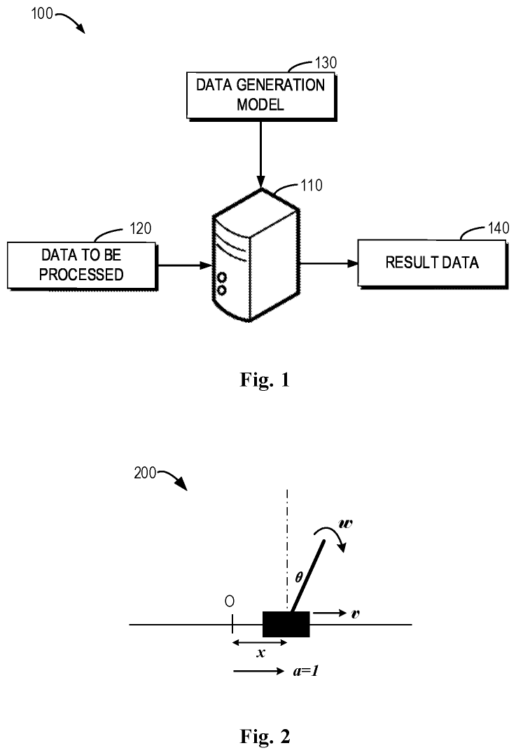

FIG. 1 illustrates a block diagram of an example environment 100 according to embodiments of the present disclosure. The environment 100 illustrated in FIG. 1 is only an example in which some embodiments of the present disclosure can be implemented, not intended for limiting the scope of the present disclosure. The embodiments of the present disclosure are also suitable for other systems or architectures.

As illustrated in FIG. 1, the environment 100 may comprise a computing device 110. The computing device 110 may be any device with computing capabilities. The computing device 110 may include, but is not limited to, a personal computer, a server computer, a portable or laptop device, a mobile device (e.g., a mobile phone, a personal digital assistant (PDA), a media player, etc.), a wearable device, a consumer electronic product, a mini computer, a main frame, a distributed computing system, and a cloud computing resource, etc. It is understood that based on considerations of factors such as costs, the computing device 110 may have or do not have sufficient computing resources for model training.

The computing device 110 may be configured to acquire data to be processed 120, and output result data 140. A determination of the result data 140 can be implemented by a trained data generation model 130.

The data to be processed 120 may be input by a user, or may be acquired from a storage device, which is not limited in the present disclosure.

The data to be processed 120 may be used to represent information of an object in a field to be processed. The data to be processed 120 may indicate at least one of: first state information, a first action, and second state information after executing the first action when the first state information is satisfied. Alternatively, the data to be processed 120 may include reward information in the process of transitioning from the first state information to the second state information after executing the first action.

The result data 140 may include information similar to the data to be processed 120. In some examples, the result data 140 may indicate at least one of: first state information, a second action, and third state information after executing the second action when the first state information is satisfied.

In some examples, the embodiments of the present disclosure can be applied to a field of smart self-balancing scooters. Correspondingly, the object may be a self-balancing scooter. State information may represent a moving state of the self-balancing scooter. For example, the state information may include a moving distance, a moving speed, an angle relative to the horizontal plane (or vertical direction), an angular velocity, and the like. The action may include moving forward, moving backward, stopping, and the like.

Alternatively, the self-balancing scooter may be simplified as a cartpole. FIG. 2 illustrates a schematic diagram of example state information 200 according to embodiments of the present disclosure. The state information may be represented as four-dimensional data: (x, \dot{x}, θ, \dot{θ}). As an example, it is assumed that: (x, \dot{x}, θ, \dot{θ})=(0.018,0.669,0.286,0.618), where x=0.018 represents a displacement relative to the origin O, i.e., it is located at the right side of the origin, and its distance from the origin is 0.018. \dot{x}=0.669 represents a moving speed (which is represented as v in FIG. 2), i.e., the movement is toward the right side of the origin, and the moving speed is equal to 0.669. θ=0.286 represents that an angle relative to the vertical direction in the clockwise direction is 0.286. \dot{θ}=0.618 represents that an angular velocity rotating in the clockwise direction a (which is represented as w in FIG. 2) is 0.618. Alternatively, supposing that moving towards the right side of the origin is moving forward, and the action is represented as a, where the action is a=1, as shown in FIG. 2.

In some examples, the embodiments of the present disclosure can be applied to the field of vehicle autonomous driving. Correspondingly, the object may be a vehicle. The state information may represent moving states of the vehicle and other surrounding vehicles. For example, the state information may be represented as ({qᵢ}_{i=0, 1, . . . , N}), where q₀ denotes the vehicle, and {qᵢ}_{i=1, . . . , N} indicates other surrounding vehicles. Alternatively, the moving state may be represented as two-dimensional data, such as qᵢ=(xᵢ, \dot{x}ᵢ,yᵢ,\dot{y}ᵢ), which indicate a displacement and a speed in a first direction and a displacement and a speed in a second direction, respectively. The action may include an action indicative of vehicle operation or an action for performing vehicle operation, for example, including, but not limited to, moving forward, moving backward, braking, steering, and the like.

It would be appreciated that the scenarios listed above are provided merely as an example, not intending to limit the scope of the present disclosure in any manner. The embodiments of the present disclosure can be applied to a variety of fields where similar problems exist, which will not be exhausted herein. In addition, the term “action” in the embodiments of the present disclosure may be referred to as, for example, “decision” or the like, and this is not limited in the present disclosure.

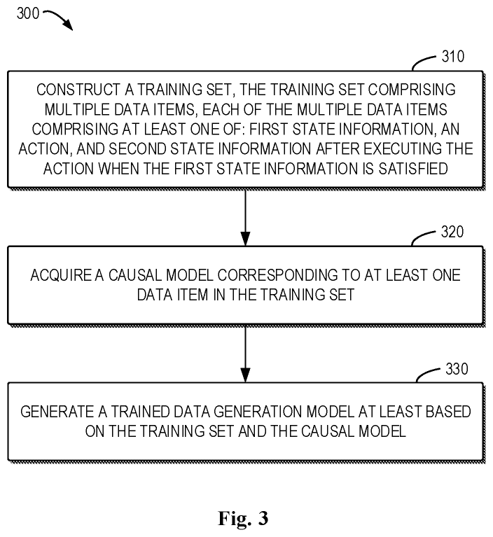

In some embodiments, prior to implementing the above process, the data generation model 130 may be trained. It is to be understood that the data generation model 130 can be trained by the computing device 110, or any other suitable device than the computing device 110. The trained data generation model 130 may be deployed within the computing device 110, or may be deployed outside the computing device 110. Hereinafter, reference will be made to FIG. 3 to describe an example training process where the data generation model 130 is trained by the computing device 110.

FIG. 3 illustrates a flowchart of an example training process 300 according to embodiments of the present disclosure. For example, the method 300 can be performed by the computing device 110 as shown in FIG. 1. It would be appreciated that the method 300 may further include additional blocks not shown and/or may skip over some shown blocks. The scope of the present disclosure is not limited in the aspect.

At block 310, a training set is constructed, where the training set includes multiple data items, and each of the multiple data items includes: first state information, an action, and second state information after executing the action when the first state information is satisfied.

At block 320, a causal model corresponding to at least one data item in the training set is acquired.

At block 330, a trained data generation model is generated at least based on the training set and the causal model.

In some embodiments of the present disclosure, the data item may be represented as D=(s, a, s′), to indicate that the action a is performed when the first state information is s, and the transitioned second state information is s′. Alternatively, in some embodiments, the data item may further include attribute information represented as λ. Correspondingly, the data item may be presented as D=(s, a, s′, λ), to indicate that an object with the attribute information λ performs the action a when the first state information is s, and the transitioned second state information is s′. Alternatively, in some embodiments, the data item further includes reward information represented as r. Correspondingly, the data item may be represented as D=(s, a, s′,r), to indicate that the action a is performed when the first state information is s, the transitioned second state information is s′, and the reward information in the process of transitioning from the first state information s to the second state information s′ is r. Alternatively, the data item may include attribute information and reward information. For example, the data item may be represented as D=(s, a, s′, r, λ), to indicate that the object with attribute information λ performs the action a when the first state information is s, the transitioned second state information is s′, and the reward information in the process of transitioning from the first state information s to the second state information s′ is r.

It is to be understood that the above example representations of the data item are provided only for illustration, and in actual scenarios, the data item may be represented in other forms, such as (action, output, attribute), where the output may include transitioned second state information, and the attribute may include first state information. Alternatively, the output may further include reward information, and the attribute may further include attribute information. Moreover, it is worth noting that the action can be set depending on the actual application scenario, which may be any item.

In some embodiments of the present disclosure, the casual model can be determined manually based on experience or the like. In some embodiments of the present disclosure, the causal model can be obtained through training based on a training set. The embodiments of the present disclosure does not limit this aspect. Exemplarily, the causal model method may include, but is not limited to, Peter-Clark (PC) Algorithm, Greedy Equivalent Search (GES), Linear non-Gaussian Model (LinGAM), Causal Additive Model (CAM), and the like.

Exemplarily, the causal model may be represented as Directed Acyclic Graph (DAG). The DAG may include multiple nodes, which include source nodes, intermediate nodes, and target nodes, for example.

Alternatively, when determining a DAG, a method of causal structure learning can be used to identify a causal structure among multiple variables. For example, when the data item includes attribute information, the attribute information can be set as the source node of the DAG.

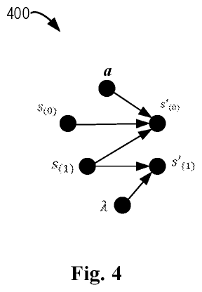

FIG. 4 illustrates a schematic diagram of DAG 400 according to some embodiments of the present disclosure. As shown therein, the node a, the node s₍₀₎, and the node s₍₁₎ are source nodes of the node s′₍₀₎, and the node s₍₁₎ and the node A are source nodes of the node s′₍₁₎. It would be appreciated that the DAG 400 shown in FIG. 4 is provided only for illustration, and in an actual scenario, the DAG may be in other forms, which is not limited in the present disclosure.

In embodiments of the present disclosure, the data generation model may include a first submodel, a second submodel, and a third submodel. During training, an initial noise parameter can be determined, which is represented as z. For example, a noise parameter obtained by random sampling can be acquired.

In some examples, the input of the second submodel may include s, a, z, and the output of the second submodel may include s′. The input of the first submodel may include s, a, s′, and the output of the first submodel may include z. The third submodel can be used to discriminate whether the output of the second submodel is real data.

In some examples, the data item further includes attribute information. The input of the second submodel may include s, a, z, λ, and the output of the second submodel may include s′. The input of the first submodel may include s, a, s′, and the output of the first submodel may include z, λ. The third submodel can be used to discriminate whether the output of the second submodel is real data.

It can be seen that the first submodel and the second submodel are adversarial with each other. The second submodel may be referred to as a generator for learning a mapping relation from s, a, z (or s, a, z, λ) to s′, aiming to generate data as close to real data as possible, for example, causing the third submodel to determine that the data generated by the second submodel are real. Exemplarily, the second submodel can at least characterize an influence of an action a (or action a and attribute information λ) on a state change (e.g. from s to s′). The first submodel may be referred to as a decoder for learning a mapping relation from s, a, s′ to z (or z, λ), aiming to be adversarial with the second submodel. The third submodel may be referred to as a discriminator. Alternatively, z, λ may be collectively referred to as influence parameter in the embodiments of the present disclosure, i.e., the influence parameter may include attribute information λ and/or a noise parameter z.

A model structure of the data generation model can be constructed based on the causal model and further trained based on the training set, so as to generate the trained data generation model. In some embodiments, the network structure of the second submodel can be constructed based on the causal model, and the first submodel, the second submodel, and the third submodel are trained, so as to obtain the trained data generation model. For example, the network structure of the second submodel may include a 2-time slice Bayesian network.

For ease of description, the first submodel is represented as E, the second submodel is represented as G, and the third submodel is represented as D. In the case, the trained E, G and D can be obtained by training at block 330.

More specifically, during training, it can be determined whether the training has been completed based on a constructed loss function. In some examples, the loss function may be expressed as Equation (1) below:

$${min}_{G , E} {max}_{D} V ( D , G , E ) = {ℒ}_{G , E} + {ℒ}_{D} + β {ℒ}_{MSE ( G )} \qquad ( 1 )$$

In Equation (1),

$${max}_{D} {ℒ}_{G , E} + {ℒ}_{D}$$

is used to discriminate discrepancies between real data and data G(z) generated by the generator. In Equation (1),

$${min}_{G , E} {ℒ}_{G , E} + {βℒ}_{MSE ( G )}$$

indicates training G and E simultaneously using paired losses, where one loss is a mean squared error (MSE) loss [symbol] _{MSE(G)} used to minimize the discrepancies, and the other loss is an adversarial loss [symbol] _{D} to enhance robustness.

Alternatively, in some examples, the training process of G can be represented as: determining the input s, a, z (or s, a, z, λ), obtaining a corresponding output s′ of G, classifying the output s′ using D, where the classified result may be true or false, and then performing a next iteration through backpropagation. In some examples, the training process of D may be represented as: determining real data from the data item, predicting a probability of transitioned second state information in the real data and obtaining a first loss, determining generated data from G, predicting a probability of transitioned second state information in the generated data and obtaining a second loss, combining the first loss with the second loss, and performing a next iteration through backpropagation, where the first loss and the second loss may be, for example, binary cross entropy (BCE) losses. It would be appreciated that E is trained simultaneously while G and D are being trained.

In this way, in the embodiments of the present disclosure, the trained data generation model is obtained by training, and the loss function in the training process can be utilized to minimize the discrepancies between the output of the second submodel and the real data by considering the mean error loss, thus accelerate the training process can be accelerated and the efficiency can be improved.

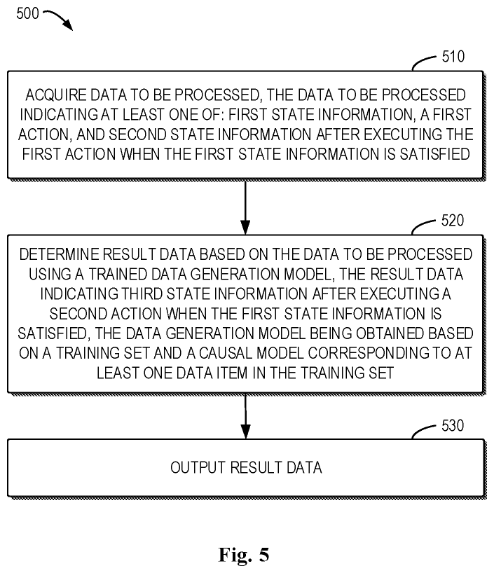

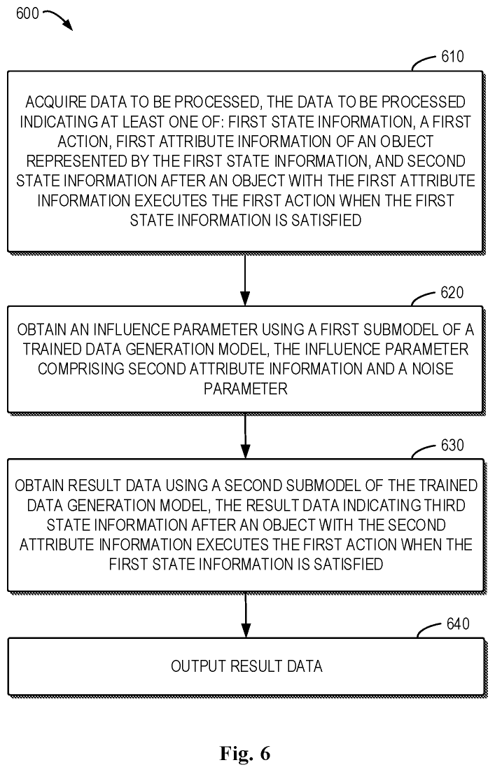

The example training process of the data generation model 130 has been described above with reference to FIGS. 3 and 4. Through the trained data generation model 130, result data corresponding to the data to be processed can be determined so that counterfactual-based data can be obtained, to thus achieve data augmentation. Hereinafter, reference will be made to FIGS. 5 and 6 to describe example usage processes of the data generation model 130.

FIG. 5 illustrates a flow chart of an example usage process 500 according to embodiments of the present disclosure. For example, the method 500 can be performed by the computing device 110 as shown in FIG. 1. It would be appreciated that the method 500 may include additional blocks not shown and/or may omit some shown blocks. The scope of the present disclosure is not limited in the aspect.

At block 510, data to be processed are acquired, where the data to be processed indicate at least one of: first state information, a first action, and second state information after executing the first action when the first state information is satisfied.

At block 520, result data are determined based on the data to be processed using a trained data generation model, where the result data indicate third state information after executing a second action when the first state information is satisfied, and the data generation model is obtained based on a training set and a causal model corresponding to at least one data item in the training set.

At block 530, the result data are output.

In the embodiments of the present disclosure, the data to be processed may be factual data collected in an actual scenario, while the result data may be counterfactual data different than the factual data, which, for example, may be represented in the following manner that: if the current action is changed while other aspects are kept unchanged, what result will be generated.

The trained data generation model used at block 520 may be the data generation model as described with reference to FIGS. 3 and 4. More specifically, the second submodel can be used at block 530 to obtain the result data.

In some embodiments, assuming that the data to be processed at block 510 can be represented as d=(s, a, s′), the result data can be represented as d′=(s, a′, s″) correspondingly. In some embodiments, assuming that the data to be processed at block 510 can be represented as d=(s, a, s′, λ), the result data can be represented as d′=(s, a″, s″, λ) correspondingly. Likewise, the process 500 as shown in FIG. 5 is performed for a large amount of data to be processed, to obtain a counterfactual dataset.

As such, according to the embodiments of the present disclosure, counterfactual data corresponding to data to be processed can be obtained using the trained data generation model.

FIG. 6 illustrates a flowchart of an example usage process 600 according to embodiments of the present disclosure. For example, the method 600 can be performed by the computing device 110 as shown in FIG. 1. It would be appreciated that the method 600 may include additional blocks not shown and/or may omit some shown blocks. The scope of the present disclosure is not limited in the aspect.

At block 610, data to be processed are acquired, where the data to be processed indicate at least one of: first state information, a first action, first attribute information of an object represented by the first state information, and second state information after an object with the first attribute information executes the first action when the first state information is satisfied.

At block 620, an influence parameter is obtained using a first submodel of a trained data generation model, where the influence parameter includes second attribute information and a noise parameter.

At block 630, result data are obtained using a second submodel of the trained data generation model, where the result data indicate third state information after an object with the second attribute information executes the first action when the first state information is satisfied.

At block 640, the result data are output.

In some embodiments, the data to be processed at block 610 can be represented as, for example, d=(s, a, s′, λ), the result data can be represented as d′=(s, a, s″, λ′) correspondingly, to indicate that, for an object s satisfying the first state information, if its attribute information is then the transitioned third state information thereof is s″ after the action a is applied to the object.

In some embodiments of the present disclosure, at block 620, the first state information, the first action and the second state information can be input into the first submodel, to obtain an influence parameter corresponding to the data to be processed, where the influence parameter may include second attribute information and a noise parameter. For example, the second attribute information may be represented as λ′, and the noise parameter may be represented as z. Further, at block 630, the first state information, the first action, and the influence parameter output by the first submodel are input into the second submodel, to thus obtain third state information. For example, the third state information may be represented as s″. Alternatively, the third submodel can be used to determine availability of result data. For instance, the first state information, the first action, and the third state information may be input into the third submodel to determine availability of the result data, for example, to determine whether the result data are real data.

The field of smart self-balancing scooters is taken as an example. As one of the means of transportation, self-balancing scooters have many advantages, such as small size, light weight, simple and stylish appearance, easy operation, and integration of entertainment and transportation, and the like. Accordingly, they have a wide range of applications, which are not only used by individual consumers, but also applied in a variety of industries such as security patrol, community service, airport ground handling, and the like. Depending on a movement of a driver's center of gravity, the self-balancing scooter implements an operation, such as acceleration, deceleration or steering. The dynamic system used in the self-balancing scooter involves multiple variables, the system parameters are coupled with each other, and the variables are time-varying and nonlinear, thus making it impossible to accurately construct the dynamic system model of the self-balancing scooter.

One approach is to collect data in some particular scenarios, and then obtain a dynamic model based on the collected data through, for example, training. However, the data collected in actual scenarios are limited. For instance, data collection can be performed only for specific drivers, causing the collected data not to be sufficiently complete.

For these scenarios, the data to be processed in embodiments of the present disclosure may be represented as d=(s,a,s′,λ), where s and s′ represent state information of the self-balancing scooter before and after the action a, the state information may be represented as four-dimensional data (x,\dot{x},θ,\dot{θ}), x is a displacement in the forward direction, and \dot{x} is the speed. θ is an inclination angle of the self-balancing scooter, for example, an angle between the body of the self-balancing scooter and the horizontal direction, or an angle between the normal line perpendicular to the body of the self-balancing scooter and the vertical direction as shown in FIG. 2. Alternatively, if it is put in another way, θ is an inclination angle of the scooter body controller relative to the rod body of the self-balancing scooter. \dot{θ} is an inclination angular velocity of the scooter body controller relative to the rod body of the self-balancing scooter, as discussed above with reference to FIG. 2, which is omitted here for brevity. λ in the data to be processed may represent attribute information of the rod body (e.g. a driver) of the self-balancing scooter, such as the driver's height.

Among data collected for a self-balancing scooter in an actual scenario, even though λ only include three values, 1.5, 1.6 and 1.8, more data for the remaining height λ′ can be obtained by applying the process 600 as shown in FIG. 6. For example, the range of λ may be a continuous interval [0.8, 2]. The result data obtained in this manner can realize expansion of the dataset. Furthermore, a better dynamic balance control system can be obtained using the expanded dataset and the collected dataset, so that the dynamic balance system can be used to maintain the user's balance operation when the user is operating. As an example, a test set can be used for the initial test, and the expanded test set can also be used for testing. Through a comparison test, it is found that, as compared with the success rate of the initial test, the success rate obtained based on the expanded test set according to the embodiments of the present disclosure is increased by about 15%. The success rate refers to a probability that the body of the self-balancing scooter remains in balance during multiple test cycles.

Take the field of autonomous driving as an example. Embodiments of the present disclosure can be applied to advanced driver assistance systems (ADAS) of vehicles. ADAS can collect environmental data inside and outside of the vehicle through various vehicle on board sensors, to perform technical processing such as identification, detection and tracking of static and dynamic objects, to alert a driver of potential dangers in the shortest time and enable the driver to take corresponding measures, to thus improve driving safety. The common finer functions can be implemented by a lane departure warning (LDW) system, a blind spot detection (BSD) system, a lane change assist (LCA) system, an adaptive cruise control (ACC) system, an autonomous emergency braking (AEB) system, a driver monitoring system (DMS), and the like.

The current common approach is to perform fault diagnosis for a vehicle based on a mechanism and the experts' experiences. However, the approach imposes higher requirements on technicians, incurring high costs. Another approach is to control the vehicle using existing data, but the currently available data contain a few fault data, not complete enough.

For the scenario, the data to be processed in the embodiments of the present disclosure may be represented as d=(s, a, s′, λ) where s and s′ represent state information of a vehicle and surrounding vehicles thereof before and after an action a, respectively, the state information may be represented as ({qᵢ}_{i=0, 1, . . . , N}), where q₀ is the vehicle, and {qᵢ}_{i=1, . . . , N} is the remaining surrounding vehicles. Alternatively, a state of each vehicle in the state information is represented as two-dimensional data, for example, qᵢ=(xᵢ,\dot{x}ᵢ,yᵢ,\dot{y}ᵢ), which indicate a displacement and a speed in a first direction, and a displacement and a speed in a second direction. The action a may include an action indicative of vehicle operation or an action for performing vehicle operation, including, but not limited to, moving forward, moving backward, braking, steering, and the like. A in the data to be processed may represent information related to an environment where the vehicle is located, including, for example, weather, time, a friction coefficient of the ground, and the like.

Further, more data for λ can be obtained by applying the process 600 as shown in FIG. 6. For example, if first attribute information λ in the data to be processed is (sunny, daytime), then data including second attribute information λ′ (sunny, night), (cloudy, daytime), (cloudy, night), (rainy, night), or the like can be concluded, and the result data obtained in this manner can expand the dataset. Moreover, an ADAS having better performance can be attained using the expanded dataset, where the expanded dataset may include an existing dataset and result data obtained according to embodiments of the present disclosure. Accordingly, during vehicle traveling, the ADAS can provide more timely and accurate pre-warning or processing, to guarantee safe traveling of the vehicle.

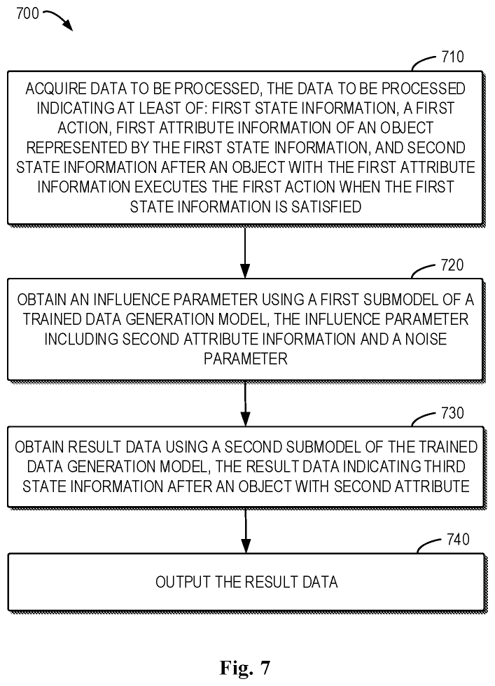

FIG. 7 illustrates a flowchart of an example usage process 700 according to embodiments of the present disclosure. For example, the method 700 may be performed by the computing device 110 as shown in FIG. 1. It would be appreciated that the method 700 may include additional blocks not shown and/or may omit some shown blocks. The scope of the disclosure is not limited in the aspect.

At block 710, data to be processed are acquired, where the data to be processed indicate at least one of: first state information, a first action, first attribute information of an object represented by the first state information, and second state information after an object with the first attribute information executes the first action when the first state information is satisfied.

At block 720, an influence parameter is obtained using a first submodel of a trained data generation model, where the influence parameter includes second attribute information and a noise parameter.

At block 730, result data are obtained using a second submodel of the trained data generation model, where the result data indicate third state information after an object with the second attribute information executes a second action when the first state information is satisfied.

At block 740, result data are output.

In some embodiments, the data to be processed at block 710 can be represented as, for example, d=(s, a, s′, λ), and the result data can be represented as d′=(s, a′, s″, λ′) correspondingly, to indicate that, for an object satisfying the first state information s, if its attribute information is λ′, then its transitioned third state information is s″ after an action a′ is applied to the object.

In some embodiments of the present disclosure, at block 720, the first state information, the first action and the second state information may be input into the first submodel, to obtain an influence parameter corresponding to the data to be processed, where the influence parameter may include second attribute information and a noise parameter. For example, the second attribute information may be represented as and the noise parameter may be represented as z. Further, at block 730, the first state information, the second action and the influence parameter output by the first submodel may be input into the second submodel, to thus obtain third state information. For instance, the third state information may be represented as s″. Alternatively, the third submodel may be used to determine availability of the result data. For example, the first state information, the second action and the third state information may be input into the third submodel, to determine availability of the result data, for example, to discriminate whether the result data are real data.

In the embodiments with reference to FIGS. 5-7, result data can be obtained based on the data to be processed, where the result data may be counterfactual data. More specifically, counterfactual data of a different action from the factual data are obtained in combination with the process 500 as shown in FIG. 5, counterfactual data of different attribute information from the factual data are obtained in combination with the process 600 as shown in FIG. 6, and counterfactual data of a different action and different attribute information from the factual data are obtained in combination with the process 700 as shown in FIG. 7.

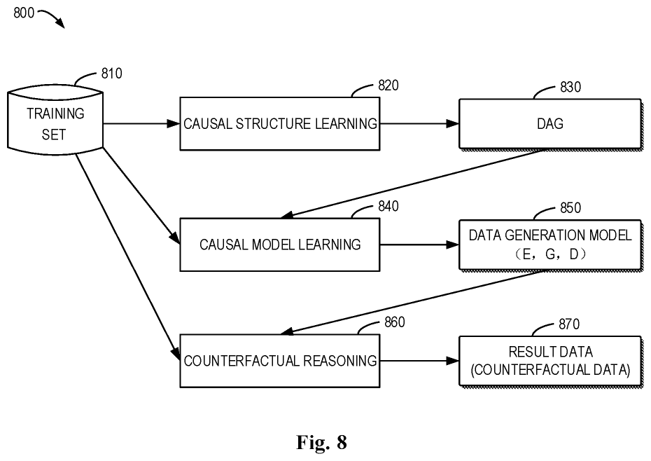

For example, the data to be processed in FIGS. 5-7 may be one of the multiple data items in the training set as shown in FIG. 3, and correspondingly, the embodiments described above may be represented illustratively as a flow process 800 as shown in FIG. 8. As shown in FIG. 8, a DAG 830 can be obtained through causal structure learning 820 based on a training set 810. A data generation model 850 can be obtained through causal model learning 840 based on the training set 810 and the DAG 830, where the data generation model 850 may include a first submodel E, a second submodel G and a third submodel D. Result data 870 can be obtained through counterfactual reasoning 860 based on the training set 810 and the data generation model 850, where the result data 870 are counterfactual data. It would be appreciated that the flow process as shown in FIG. 8 is provided only for illustration, which should not be construed as limiting the embodiments of the present disclosure.

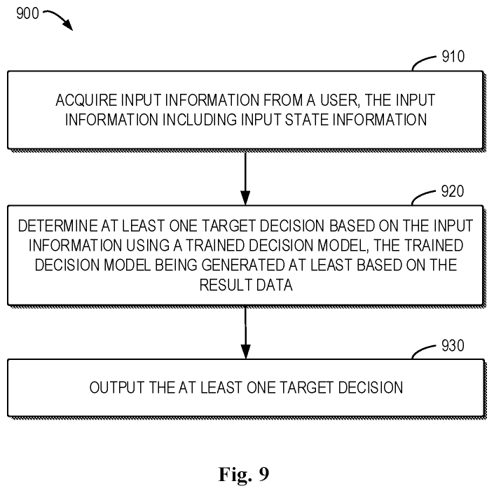

FIG. 9 illustrates a schematic flowchart of a process 900 of determining a target decision according to embodiments of the present disclosure.

At block 910, input information is acquired from a user, where the input information includes input state information.

At block 920, at least one target decision is determined based on the input information using a trained decision model, where the trained decision model is generated at least based on the result data.

At block 930, the at least one target decision is output.

In some embodiments, the trained decision model may be obtained by: constructing a decision training set, where the decision training set includes multiple decision data items, and each decision data item includes at least one of: attribute information, initial state information, a decision, transitioned state information after applying the decision when the initial state information is satisfied, and reward information in a process from the initial state information to the transitioned state information; and generating the trained decision model at least based on the decision training set. Exemplarily, at least one of the multiple decision data items is counterfactual data generated based on the process discussed above.

The decision model may include a set of state information, a set of decisions, a transition function and a reward function. The transition function may represent a probability of state information transition caused by applying a decision, and the reward function may be used to represent a reward obtained by applying a decision.

Alternatively, in some embodiments, input information of a user may further include indication information about an output condition. At block 920, a series of target decisions, for example, multiple target decisions, can be determined until the output condition is met. At block 930, the multiple target decisions can be output. In some embodiments, a first decision solution corresponding to the input state information can be determined based on a trained decision model, and a first target decision is then determined based on the first decision solution. Exemplarily, the first decision solution may include multiple decisions and multiple corresponding assessment values, and the decision corresponding to the maximum assessment value among the multiple assessment values may be taken as the first target decision. Transitioned state information after applying the first target decision when the input state information is satisfied can be determined. Subsequently, a second decision solution corresponding to the transitioned state information can be determined based on the trained decision model, and a second target decision is then determined based on the second decision solution. In this way, multiple target decisions that meet the output condition can be determined, where the multiple target decisions includes the first target decision, the second target decision, . . . .

It is noted that the output condition is not limited in the present disclosure. For example, the output condition includes at least one of: a number of the output target decisions is equal to a preset value, state information after applying multiple target decisions is preset state information, a total reward in a process of applying the multiple target decisions is greater than a first predetermined value, a total reward in a process of applying the multiple target decisions is less than the first predetermined value, and the like.

Therefore, in the embodiments of the present disclosure, the decision dataset includes counterfactual data while generating a decision model. In this way, more data can be taken into account, enabling the obtained decision model to be applied in a wider range. Specifically, the target decision obtained based on the decision model is more accurate.

In this way, a data generation model can be obtained through training, to obtain counterfactual result data based on the data to be processed. In addition, the result data can be used for training to obtain a decision mode, to make the at least one target decision obtained based on the decision model more accurate.

In some embodiments, the computing device includes circuitry configured to perform operations of: acquiring data to be processed, the data to be processed indicating at least one of: first state information, a first action, and second state information after executing the first action when the first state information is satisfied; determining result data based on the data to be processed using a trained data generation model, the result data indicating third state information after executing a second action when the first state information is satisfied, and the data generation model being obtained based on a training set and a causal model corresponding to at least one data item in the training set; and outputting the result data.

In some embodiments, the computing device includes circuitry configured to perform operations of: inputting at least one of the first state information, the first action, and the second state information into a first submodel, to obtain an influence parameter corresponding to the data to be processed; and inputting the first state information, the second action and the influence parameter into a second submodel, to obtain third state information.

In some embodiments, the influence parameter includes at least one of: attribute information of an object represented by the first state information, or a noise parameter.

In some embodiments, the data to be processed are factual-based data, and the result data are counterfactual data.

In some embodiments, the computing device includes circuitry configured to perform an operation of: inputting the first state information, the second action and the third state information into a third submodel, to determine availability of the result data.

In some embodiments, the computing device includes circuitry configured to perform operations of: acquiring input information from a user, where the input information includes input state information; determining at least one target decision based on the input information using a trained decision model, where the trained decision model is generated at least based on the result data; and outputting at least one target decision.

In some embodiments, the computing device includes circuitry configured to perform operations of: acquiring data to be processed, where the data to be processed indicate at least one of: first state information, a first action, first attribute information, and second state information after an object with the first attribute information executes the first action when the first state information is satisfied; inputting at least one of the first state information, the first action, and the second state information into a first submodel of a trained data generation model to obtain an influence parameter corresponding to the data to be processed, where the influence parameter includes second attribute information and a noise parameter; inputting the first state information, the first action, and the influence parameter into a second submodel of the trained data generation model to obtain result data, where the result data indicates third state information after an object with the second attribute information executes the first action when the first state information is satisfied; and outputting the result data.

In some embodiments, the computing device includes circuitry configured to perform operations of: constructing a training set, where the training set includes a plurality of data items, where each of the plurality of data items includes at least one of: first state information, an action, and second state information after executing the action when the first state information is satisfied; acquiring a causal model corresponding to at least one data item in the training set; and generating a trained data generation model at least based on the training set and the causal model.

In some embodiments, each of the plurality of data items further includes attribute information of the object represented by the first state information.

In some embodiments, the data generation model includes a first submodel, a second submodel, and a third submodel, where an input of the first submodel includes first state information, an action and second state information, an input of the second submodel includes first state information, an action and attribute information, and the third submodel is used to determine discrepancies between an output of the second submodel and the second state information.

In some embodiments, the input of the second submodel further includes an influence parameter, where the influence parameter includes at least one of: attribute information of the object represented by the first state information, or a noise parameter.

In some embodiments, the computing device includes circuitry configured to perform an operation of: generating the causal model based on at least one data item in the plurality of data items, where the causal model indicates causal relations among a plurality of factors in the at least one data item.

In some embodiments, the computing device includes circuitry configured to perform operations of: constructing a model structure of the data generation model based on the causal model; and training the model structure at least based on the training set to generate the trained data generation model.

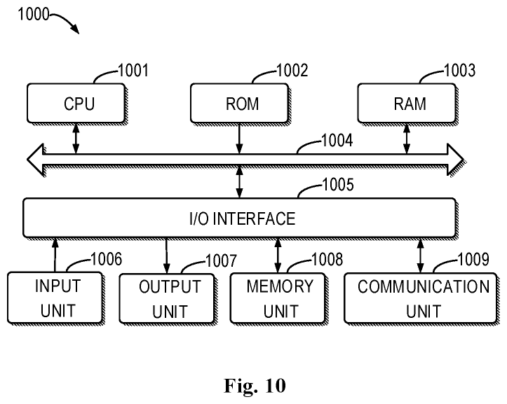

FIG. 10 illustrates a schematic block diagram of an example device 1000 that is suitable for implementing embodiments of the present disclosure. For example, the computing device 110 as shown in FIG. 1 may be implemented by the device 1000. As illustrated therein, the device 1000 includes a central processing unit (CPU) 1001 that may perform various appropriate actions and processing based on computer program instructions stored in a read-only memory (ROM) 1002 or loaded from a memory unit 708 to a random-access memory (RAM) 1003. In the RAM 1003, there may further store various programs and data needed for operations of the device 1000. The CPU 1001, ROM 1002 and RAM 1003 are connected to each other via a bus 1004. An input/output (I/O) interface 1005 is also connected to the bus 1004.

Various components in the device 1000 are connected to the I/O interface 1005, including: an input unit 1006 such as a keyboard, a mouse and the like; an output unit 1007 such as various types of displays and loudspeakers, etc.; a memory unit 1008 such as a magnetic disk, an optical disk, and etc.; and a communication unit 1009 such as a network card, a modem, and a wireless communication transceiver, etc. The communication unit 1009 allows the device 1000 to exchange information/data with other devices via a computer network such as the Internet and/or various types of telecommunications networks. It is understood that the present disclosure may display, via the output unit 1007, real-time dynamic change information of the customer satisfaction, key factor identification information of a group of customers or individual customers subjected to the satisfaction, optimized strategy information, and strategy implementation effect assessment information, etc.

The processing unit 1001 may be implemented by one or more processing circuits. The processing unit 1001 may be configured to perform various processes and processing described above. For example, in some embodiments, the process described above may be implemented as a computer software program that is tangibly embodied on a machine readable medium, e.g., the memory unit 1008. In some embodiments, part or all of the computer program may be loaded and/or mounted onto the device 1000 via ROM 1002 and/or communication unit 1009. When the computer program is loaded to the RAM 1003 and executed by the CPU 1001, one or more steps of the process as described above may be executed.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to optimal explain the principles of the embodiments, the practical application or technical improvement over technologies found in the marketplace, or to enable others of ordinary skill in the art to understand the embodiments disclosed herein.

I/We claim:

1. A data processing method, comprising:
acquiring data to be processed, the data to be processed indicating at least one of: first state information, a first action, and second state information after executing the first action when the first state information is satisfied;
determining result data based on the data to be processed using a trained data generation model, the result data indicating third state information after executing a second action when the first state information is satisfied, and the data generation model being obtained based on a training set and a causal model corresponding to at least one data item in the training set; and
outputting the result data.

2. The method according to claim 1, wherein the data generation model comprises a first submodel and a second submodel, and wherein determining the result data comprises:
inputting at least one of the first state information, the first action, and the second state information into the first submodel, to obtain an influence parameter corresponding to the data to be processed; and
inputting the first state information, the second action, and the influence parameter into the second submodel, to obtain the third state information.

3. The method according to claim 2, wherein the influence parameter comprises at least one of: attribute information of an object represented by the first state information, or a noise parameter.

4. The method according to claim 2, wherein the data generation model further comprises a third submodel, and the method further comprises:
inputting the first state information, the second action, and the third state information into the third submodel, to determine availability of the result data.

5. The method according to claim 1, further comprising:
acquiring input information from a user, the input information comprising input state information;
determining at least one target decision based on the input information using a trained decision model generated at least based on the result data; and
outputting the at least one target decision.

6. The method according to claim 1, further comprising:
constructing the training set, the training set comprising a plurality of data items, each of the plurality of data items comprising at least one of: first state information, an action, and second state information after executing the action when the first state information is satisfied;
acquiring the causal model; and
generating the trained data generation model at least based on the training set and the causal model.

7. The method according to claim 6, wherein each of the plurality of data items further comprises attribute information of an object represented by the first state information.

8. The method according to claim 7, wherein the data generation model comprises a first submodel, a second submodel, and a third submodel, and wherein
an input of the first submodel comprises the first state information, the action, and the second state information,
an input of the second submodel comprises the first state information, the action, and the attribute information, and
the third submodel is used to determine discrepancies between an output of the second submodel and the second state information.

9. The method according to claim 8, wherein an input of the second submodel further comprises an influence parameter, and the influence parameter comprises at least one of: attribute information of an object represented by the first state information, or a noise parameter.

10. The method according to claim 6, wherein acquiring the causal model comprises:
generating the causal model based on at least one data item in the plurality of data items, wherein the causal model indicates causal relations among a plurality of factors in the at least one data item.

11. The method according to claim 6, wherein generating the trained data generation model comprises:
constructing a model structure of the data generation model based on the causal model; and
training the model structure at least based on the training set, to generate the trained data generation model.

12. The method according to claim 1, wherein the data to be processed is factual-based data, and the result data is counterfactual data.

13. A model training method, comprising:
constructing a training set, the training set comprising a plurality of data items, each of the plurality of data items comprising at least one of: first state information, an action, and second state information after executing the action when the first state information is satisfied;
acquiring a causal model corresponding to at least one data item in the training set; and
generating a trained data generation model at least based on the training set and the causal model.

14. The method according to claim 13, wherein each of the plurality of data items further comprises attribute information of an object represented by the first state information.

15. The method according to claim 14, wherein the data generation model comprises a first submodel, a second submodel, and a third submodel, and wherein
an input of the first submodel comprises the first state information, the action, and the second state information,
an input of the second submodel comprises the first state information, the action, and the attribute information, and
the third submodel is used to determine discrepancies between an output of the second submodel and the second state information.

16. The method according to claim 15, wherein the input of the second submodel further comprises an influence parameter, and wherein the influence parameter comprises at least one of: attribute information of an object represented by the first state information, or a noise parameter.

17. The method according to claim 13, wherein acquiring the causal model comprises:
generating the causal model based on at least one data item in the plurality of data items, wherein the causal model indicates causal relations among a plurality of factors in the at least one data item.

18. The method according to claim 13, wherein generating the trained data generation model comprises:
constructing a model structure of the data generation model based on the causal model; and
training the model structure at least based on the training set, to generate the trained data generation model.

19. An electronic device comprising at least one processing unit configured to cause the electronic device to:
acquire data to be processed, the data to be processed indicating at least one of: first state information, a first action, and second state information after executing the first action when the first state information is satisfied;
determine result data based on the data to be processed using a trained data generation model, the result data indicating third state information after executing a second action when the first state information is satisfied, and the data generation model being obtained based on a training set and a causal model corresponding to at least one data item in the training set; and
output the result data.

20. The device of claim 19, wherein the at least one processing unit is further configured to cause the electronic device to:
construct the training set, the training set comprising a plurality of data items, each of the plurality of data items comprising at least one of: first state information, an action, and second state information after executing the action when the first state information is satisfied;
acquire the causal model; and
generate the trained data generation model at least based on the training set and the causal model.
